(19) United States
(12) Patent Application Publication
(10) Pub. No.: US 2023/0099847 A1
(43) Pub. Date: Mar. 30, 2023

(54) Cable Core Wire Orientation Adjustment System

(71) Applicants: Tyco Electronics (Shanghai) Co. Ltd., Shanghai (CN); TE Connectivity Services GmbH, Schaffhausen (CH)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: Tyco Electronics (Shanghai) Co. Ltd., Shanghai (CN); TE Connectivity Services GmbH, Schaffhausen (CH)

(21) Appl. No.: 17/956,005

(22) Filed: Sep. 29, 2022

(30) Foreign Application Priority Data
Sep. 29, 2021 (CN) 2021-11152835.5

(51) Int. Cl. B21D 43/00

(52) U.S. Cl. CPC B21D 43/003; H02G 1/12

(57) ABSTRACT

A cable core wire orientation adjustment system includes a cable rotation module adjusting two core wires of a cable exposed from an end of the cable to a predetermined orientation by rotating the end of the cable. The cable core wire orientation adjustment system can automatically adjust the orientation of the two exposed core wires at the end of the cable, improving the orientation adjustment efficiency of the cable core wires.

### CROSS-REFERENCE TO RELATED APPLICATION

This application claims the benefit of the filing date under 35 U.S.C. § 119(a)-(d) of Chinese Patent Application No. 202111152835.5, filed on Sep. 29, 2021.

### FIELD OF THE INVENTION

The present invention relates to an adjustment system and, more particularly, to a cable core wire orientation adjustment system.

### BACKGROUND

Before connecting a cable with two core wires to a connector or terminal, it is necessary to remove a section of the outer sheath at the end of the cable to expose the two core wires. Sometimes, before the next step of processing the cable, it is necessary to rotate the exposed two core wires of the cable to a predetermined orientation, so that the connecting line between the centers of the exposed two core wires of the cable is in a horizontal direction, and one core wire is located at the predetermined side relative to the other core wire. The orientation of the exposed two core wires of the cable is usually rotated and adjusted manually, and the efficiency of manually adjusting the orientation is very low.

### SUMMARY

A cable core wire orientation adjustment system includes a cable rotation module adjusting two core wires of a cable exposed from an end of the cable to a predetermined orientation by rotating the end of the cable. The cable core wire orientation adjustment system can automatically adjust the orientation of the two exposed core wires at the end of the cable, improving the orientation adjustment efficiency of the cable core wires.

### BRIEF DESCRIPTION OF THE DRAWINGS

The features of the present invention will become more apparent by describing in detail exemplary embodiments thereof with reference to the accompanying drawings, in which:

FIG. 1 is a perspective view of a cable according to an embodiment;

FIG. 2 is a schematic diagram of adjusting the exposed two core wires of the cable to the predetermined orientation by rotating the end of the cable;

FIG. 3 is a perspective view of a cable core wire orientation adjustment system according to an embodiment;

FIG. 4 is a perspective view of a cable rotation module of the cable core wire adjustment system showing a clamped cable;

FIG. 5 is a perspective view of the cable rotation module without the cable and with a gripper in a closed position;

FIG. 6 is a schematic diagram of a drive mechanism driving the opening and closing of the gripper, with the gripper in the closed position;

FIG. 7 is a perspective view of the cable rotation module without the cable and with the gripper in an open position;

FIG. 8 is a schematic diagram of the drive mechanism with the gripper in the open position;

FIG. 9 is a perspective view of a visual unit of the cable core wire orientation adjustment system; and

FIG. 10 is a schematic diagram of rotating both ends of the cable simultaneously with the cable core wire orientation adjustment system.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

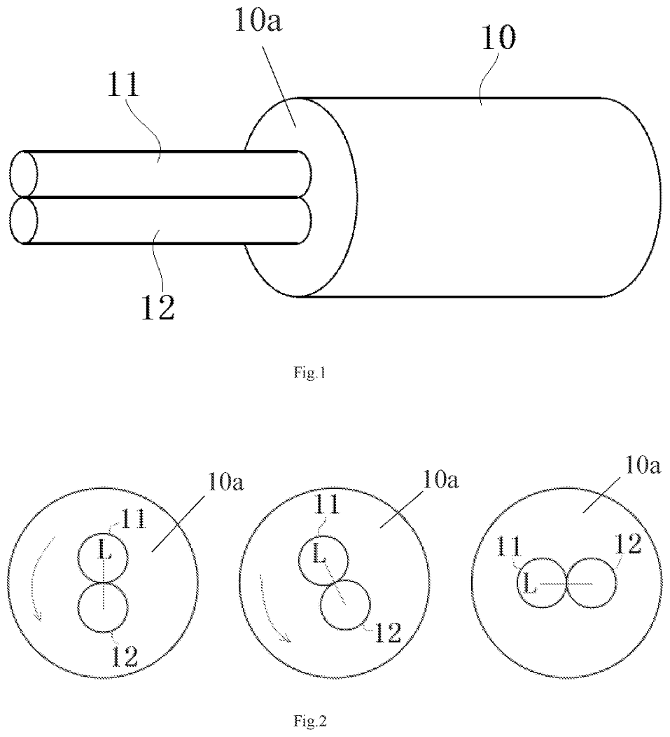

FIG. 1 shows an illustrative perspective view of a cable 10 according to an exemplary embodiment of the present invention. An end 10a of the cable 10 is shown in FIG. 1, with a portion of an insulation removed to expose a pair of core wires 11 and 12 of the cable 10.

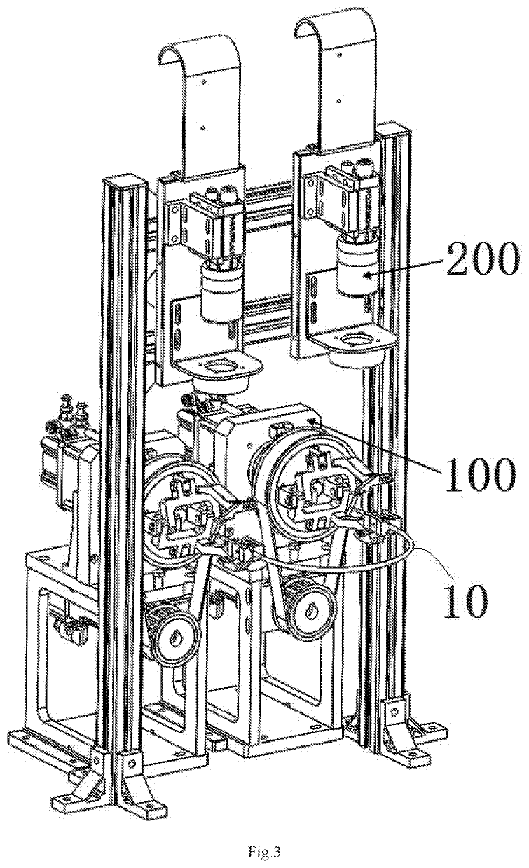

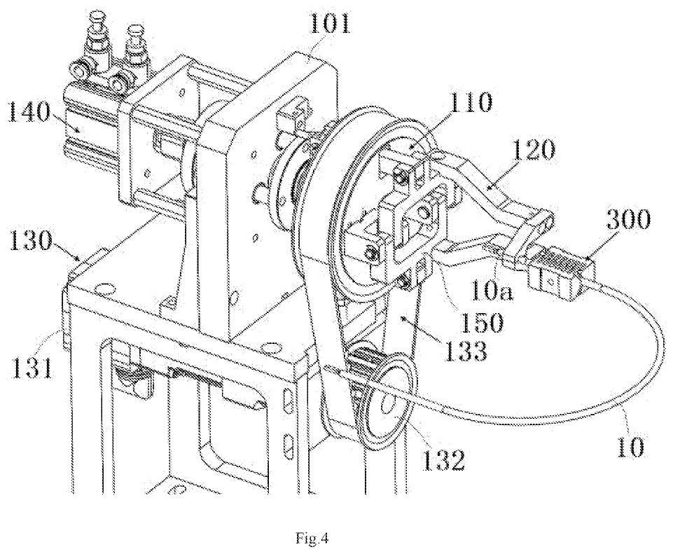

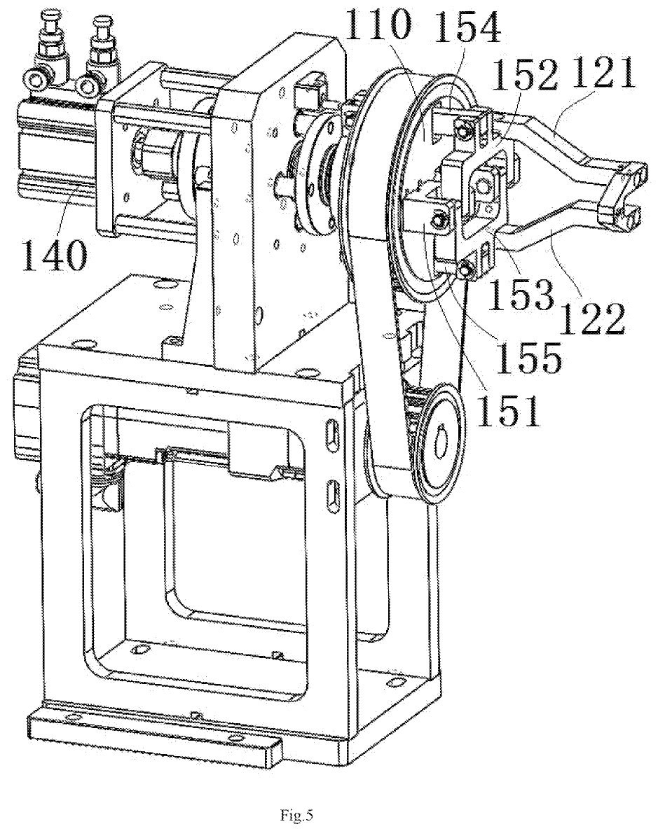

FIG. 2 shows an illustrative view of adjusting the exposed two core wires 11 and 12 of the cable 10 to the predetermined orientation by rotating the end 10a of the cable 10. FIG. 3 shows an illustrative perspective view of a cable core wire orientation adjustment system according to an exemplary embodiment of the present invention. FIG. 4 shows an illustrative perspective view of a cable rotation module 100 of the cable core wire orientation adjustment system shown in FIG. 3, showing a cable 10 clamped.

As shown in FIGS. 3 and 4, in the illustrated embodiment, the cable core wire orientation adjustment system includes a cable rotation module 100. The cable rotation module 100 is suitable for adjusting the two core wires 11 and 12 exposed from the end 10a of the cable 10 to a predetermined orientation by rotating the end 10a of the cable 10.

As shown in FIG. 2, in the illustrated embodiment, when the exposed two core wires 11 and 12 of the cable 10 are adjusted to the predetermined orientation by rotating the end 10a of the cable 10, a connecting line L between the centers of the two core wires 11 and 12 is in a horizontal direction, and one core wire 11 of the two core wires 11 and 12 is located at a predetermined side relative to the other core wire 12. In the illustrated embodiment, after being adjusted to the predetermined orientation, the connecting line L between the center of the core wire 11 and the core wire 12 is in the horizontal direction, and the core wire 11 is located at the left side of the core wire 12.

As shown in FIG. 4, the cable rotation module 100 includes a fixed frame 101, a rotating wheel 110, and a gripper 120. The rotating wheel 110 is rotatably mounted on the fixed frame 101 and can rotate around a horizontal rotation axis. The gripper 120 is adapted to grip the end 10a of the cable 10. The gripper 120 is mounted on the rotating wheel 110 so that the end 10a of the cable 10 clamped by the gripper 120 can be rotated by rotating the rotating wheel 110. When the gripper 120 clamps the end 10a of the cable 10, the central axis of the end 10a of the cable 10 coincides with the horizontal rotation axis of the rotating wheel 110.

As shown in FIG. 4, in the illustrated embodiment, the cable rotation module 100 also includes a driving device 130, which is installed on the fixed frame 101 to drive the rotating wheel 110 to rotate.

As shown in FIG. 4, the drive device 130 includes a servo motor 131, a drive wheel 132, and a drive belt 133. The servo motor 131 is mounted on the fixed frame 101. The drive wheel 132 is connected to the output shaft of the servo motor 131. The drive belt 133 is connected between the drive wheel 132 and the rotating wheel 110.

As shown in FIG. 4, in the illustrated embodiment, the cable rotation module 100 also includes a drive mechanism 140, 150 for driving the gripper 120 to open or close to loosen or clamp the end 10a of the cable 10.

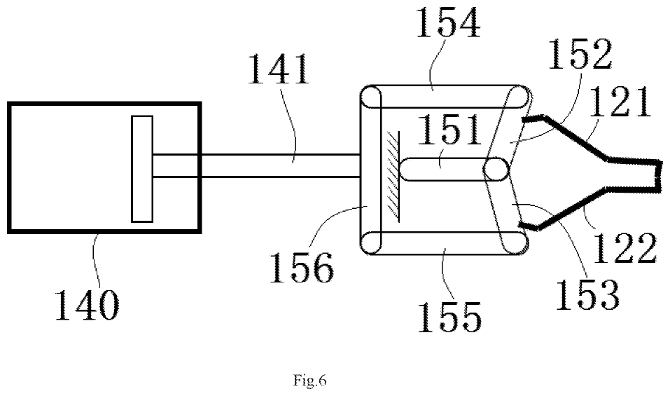

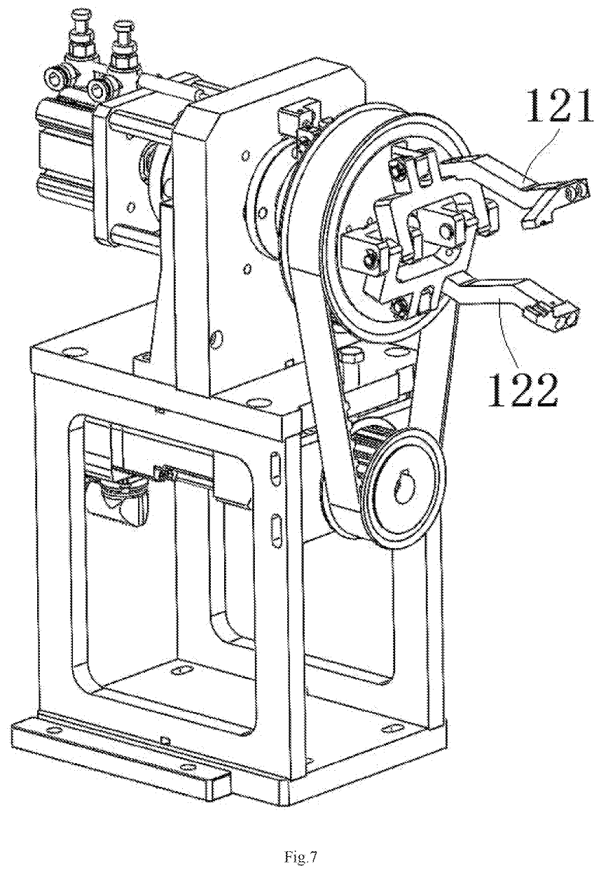

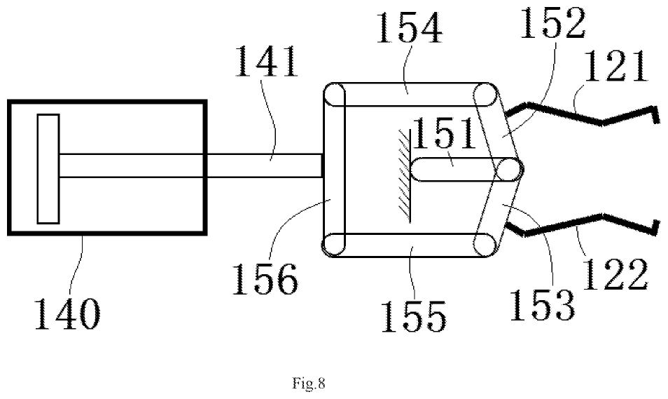

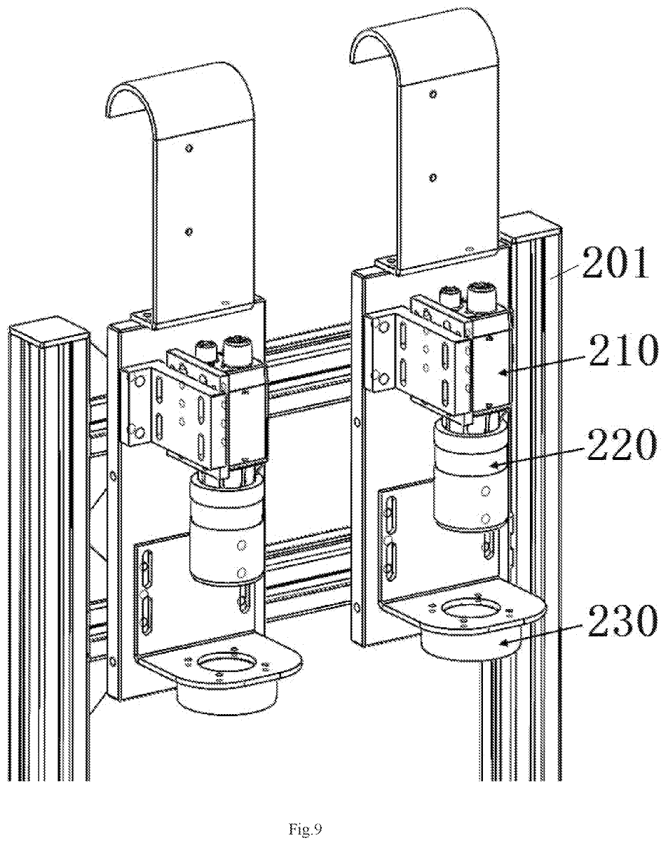

FIG. 5 shows an illustrative perspective view of a cable rotation module 100 of the cable core wire orientation adjustment system shown in FIG. 3, in which the clamped cable 10 is not shown and the gripper 120 is in the closed position. FIG. 6 shows an illustrative view of the drive mechanism 140, 150 of the cable rotation module 100 shown in FIG. 5 for driving the gripper 120 to open and close, wherein the gripper 120 is in the closed position. FIG. 7 shows an illustrative perspective view of a cable rotation module 100 of the cable core wire orientation adjustment system shown in FIG. 3, in which the clamped cable 10 is not shown and the gripper 120 is in the open position. FIG. 8 shows a schematic diagram of the drive mechanism 140, 150 of the cable rotation module 100 shown in FIG. 7 for driving the gripper 120 to open and close, wherein the gripper 120 is in the open position.

The driving mechanism 140, 150 includes a connecting rod mechanism 150, shown in FIG. 4. The gripper 120 is fixed to the connecting rod mechanism 150, which is mounted on the rotating wheel 110 and is adapted to be moved between a first state (the state shown in FIGS. 4-6) and a second state (the state shown in FIGS. 7-8).

As shown in FIGS. 4 to 6, in the illustrated embodiment, when the connecting rod mechanism 150 is moved to the first state, the gripper 120 is driven to the closed position by the connecting rod mechanism 150 to be able to clamp the end 10a of the cable 10.

As shown in FIGS. 7 and 8, in the illustrated embodiment, when the connecting rod mechanism 150 is moved to the second state, the gripper 120 is driven to the open position by the connecting rod mechanism 150 to be able to loosen the end 10a of the cable 10.

The driving mechanism 140 and 150 also includes a cylinder 140, shown in FIGS. 4-6 and 8. The cylinder 140 is mounted on the gripper 101. A telescopic rod 141 of the cylinder 140 is rotationally connected to the connecting rod mechanism 150 to drive the connecting rod mechanism 150 to move between the first state and the second state.

As shown in FIGS. 5, 6, and 8, in the illustrated embodiment, the connecting rod mechanism 150 includes: a first connecting rod 151, one end of which is fixed to the rotating wheel 110; a second connecting rod 152, one end of which is rotatably connected to the other end of the first connecting rod 151; a third connecting rod 153, one end of which is rotatably connected to the other end of the first connecting rod 151; a fourth connecting rod 154, one end of which is rotatably connected to the other end of the second connecting rod 152; a fifth connecting rod 155, one end of which is rotatably connected to the other end of the third connecting rod 153; and a sixth connecting rod 156, both ends of which are rotationally connected to the other ends of the fourth connecting rod 153 and the fifth connecting rod 155 respectively.

As shown in FIGS. 5 to 8, in the illustrated embodiment, the gripper 120 includes a first clamping arm 121 and a second clamping arm 122. The first clamping arm 121 and the second clamping arm 122 are fixed to the second connecting rod 152 and the third connecting rod 153, respectively. The telescopic rod 141 of the cylinder 140 is rotationally connected to the sixth connecting rod 156. The first connecting rod 151, the second connecting rod 152, the third connecting rod 153 and the gripper 120 are located at one side of the rotating wheel 110. The fourth connecting rod 154 and the fifth connecting rod 155 pass through the rotating wheel 110, respectively. The sixth connecting rod 156 is located at the other side of the rotating wheel 110. The second connecting rod 152 and the third connecting rod 153 are identical, and the fourth connecting rod 154 and the fifth connecting rod 155 are identical.

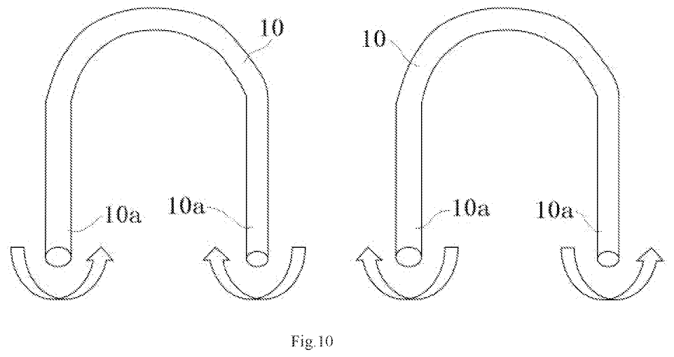

As shown in FIG. 3 and FIG. 9, in the illustrated embodiment, the cable core wire orientation adjustment system also includes a visual unit 200. The cable rotation module 100 is adapted to rotate the end 10a of the cable 10 under the visual guidance of the visual unit 200 until the exposed two core wires 11 and 12 of the cable 10 are adjusted to the predetermined orientation.

As shown in FIG. 9, in the illustrated embodiment, the visual unit 200 includes: a bracket 201, an imaging module 210, 220, 230 and a determination unit, which is a functional module composed of software stored on a non-transitory computer readable medium and hardware running on a computer. The imaging module 210, 220 and 230 is installed on the bracket 201 for capturing the image of the end 10a of the cable 10. The determination unit is adapted to determine whether the two exposed core wires 11 and 12 of the cable 10 have been adjusted to the predetermined orientation according to the captured image.

As shown in FIG. 9, the imaging module 210, 220, 230 includes a camera 210, a focusing lens 220, and a light source 230. The camera 210 is used to capture an image of the end 10a of the cable 10. The focusing lens 220 is used to adjust the focal length of the camera 210. The light source 230 is used to emit illumination light to the end 10a of the cable 10. In the illustrated embodiment, the cable core wire orientation adjustment system includes two imaging modules 210, 220, 230, which are arranged side by side for taking images of the two ends 10a of the cable 10 respectively.

FIG. 10 shows an illustrative view of rotating both ends 10a of cable 10 at the same time by the cable core wire orientation adjustment system shown in FIG. 3.

As shown in FIG. 3, in the illustrated embodiment, the cable core wire orientation adjustment system includes two cable rotation modules 100, which are arranged side by side to rotate the two ends 10a of the cable 10 respectively, so that the exposed core wires 11 and 12 at both ends of the cable 10 can be adjusted to the predetermined orientation at the same time. In the process of adjusting the orientation of the exposed core wires 11 and 12 at both ends of the cable 10, the two cable rotation modules 100 rotate the two ends 10a of the cable 10 in opposite directions (as shown in FIG. 10) to reduce or avoid distortion of the cable 10.

As shown in FIG. 4, in the illustrated embodiment, the cable core wire orientation adjustment system also includes a conveying device 300 for clamping and moving the end 10a of the cable 10. After the orientation of the core wires 11 and 12 of the cable 10 has been adjusted to the predetermined orientation, the conveying device 300 clamps the end 10a of the cable 10 and moves the end 10a of the cable 10 to the next processing station. In addition, before adjusting the orientation of the core wires 11 and 12 of the cable 10, the conveying device 300 clamps the end 10a of the cable 10 and moves the end 10a of the cable 10 to the gripper 120 of the cable rotation module 100.

In the foregoing exemplary embodiments according to the present invention, the cable core wire orientation adjustment system can automatically adjust the orientation of the two exposed core wires at the end of the cable, improving the orientation adjustment efficiency of the cable core wires.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable core wire orientation adjustment system, comprising:
a cable rotation module adjusting a pair of core wires of a cable exposed from an end of the cable to a predetermined orientation by rotating the end of the cable.

2. The cable core wire orientation adjustment system according to claim 1, wherein when the core wires of the cable are adjusted to the predetermined orientation, a connecting line between a pair of centers of the core wires is in a horizontal direction, and one of the core wires is on a predetermined side relative to the other of the core wires.

3. The cable core wire orientation adjustment system according to claim 1, wherein the cable rotation module includes:
a fixed frame;
a rotating wheel rotatably mounted on the fixed frame and rotatable around a horizontal rotation axis; and
a gripper clamping the end of the cable, the gripper is installed on the rotating wheel, the end of the cable clamped by the gripper is rotated by rotating the rotating wheel.

4. The cable core wire orientation adjustment system according to claim 3, wherein when the gripper clamps the end of the cable, a central axis of the end of the cable coincides with the horizontal rotation axis.

5. The cable core wire orientation adjustment system according to claim 3, wherein the cable rotation module includes a driving device installed on the fixed frame and driving the rotating wheel to rotate.

6. The cable core wire orientation adjustment system according to claim 5, wherein the driving device includes:
a servo motor mounted on the fixed frame;
a drive wheel connected to an output shaft of the servo motor; and
a drive belt connected between the drive wheel and the rotating wheel.

7. The cable core wire orientation adjustment system according to claim 3, wherein the cable rotation module includes a driving mechanism driving the gripper to open or close to loosen or clamp the end of the cable.

8. The cable core wire orientation adjustment system according to claim 7, wherein the driving mechanism includes a connecting rod mechanism, the gripper is fixed to the connecting rod mechanism, and the connecting rod mechanism is installed on the rotating wheel and is movable between a first state and a second state.

9. The cable core wire orientation adjustment system according to claim 8, wherein, when the connecting rod mechanism is moved to the first state, the gripper is driven to a closed position by the connecting rod mechanism to clamp the end of the cable, and when the connecting rod mechanism is moved to the second state, the gripper is driven to an open position by the connecting rod mechanism to loosen the end of the cable.

10. The cable core wire orientation adjustment system according to claim 9, wherein the driving mechanism includes a cylinder installed on the fixed frame, a telescopic rod of the cylinder is rotationally connected to the connecting rod mechanism to drive the connecting rod mechanism to move between the first state and the second state.

11. The cable core wire orientation adjustment system according to claim 10, wherein the connecting rod mechanism includes:
a first connecting rod having an end fixed to the rotating wheel;
a second connecting rod having an end rotatably connected to another end of the first connecting rod;
a third connecting rod having an end rotatably connected to the another end of the first connecting rod;
a fourth connecting rod having an end rotationally connected to another end of the second connecting rod;
a fifth connecting rod having an end rotatably connected to another end of the third connecting rod; and
a sixth connecting rod having a pair of ends respectively rotationally connected to another end of the fourth connecting rod and to another end of the fifth connecting rod.

12. The cable core wire orientation adjustment system of claim 11, wherein the gripper has a first clamping arm and a second clamping arm respectively fixed to the second connecting rod and the third connecting rod, the telescopic rod of the cylinder is rotationally connected to the sixth connecting rod.

13. The cable core wire orientation adjustment system according to claim 1, further comprising a visual unit, the cable rotation module rotates the end of the cable under visual guidance of the visual unit until the core wires of the cable are adjusted to the predetermined orientation.

14. The cable core wire orientation adjustment system according to claim 13, wherein the visual unit includes a support, an imaging module mounted on a bracket for capturing an image of the end of the cable, and a determination unit determining whether the core wires of the cable have been adjusted to the predetermined orientation according to the image.

15. The cable core wire orientation adjustment system according to claim 14, wherein the imaging module includes a camera capturing the image of the end of the cable, a focusing lens adjusting a focal length of the camera, and a light source emitting illumination light to the end of the cable.

16. The cable core wire orientation adjustment system according to claim 14, wherein the imaging module is one of a pair of imaging modules arranged side by side for taking images of a pair of ends of the cable respectively.

17. The cable core wire orientation adjustment system according to claim 1, wherein the cable rotation module is one of a pair of cable rotation modules arranged side by side for rotating a pair of ends of the cable respectively, the core wires at the ends of the cables are adjustable to the predetermined orientation simultaneously.

18. The cable core wire orientation adjustment system according to claim 17, wherein, while adjusting an orientation of the core wires at the ends of the cable, the cable rotation modules rotate the two of the cable in opposite directions.

19. The cable core wire orientation adjustment system according to claim 1, further comprising a conveying device clamping and moving the end of the cable, and after the core wires have been adjusted to the predetermined orientation, the conveying device clamps the end of the cable and moves the end of the cable to a next processing station.

20. The cable core wire orientation adjustment system according to claim 19, wherein, before adjusting the core wires, the conveying device clamps the end of the cable and moves the end of the cable to a gripper of the cable rotation module.
